(19) United States
(12) Patent Application Publication
(10) Pub. No.: US 2016/0328205 A1
(43) Pub. Date: Nov. 10, 2016

(54) Method and Apparatus for Voice Operation of Mobile Applications Having Unnamed View Elements

(71) Applicant: Motorola Mobility LLC, Chicago, IL (US)

(72) Inventors: Amit Kumar Agrawal, Bangalore (IN); Raymond B. Essick, Glen Ellyn, IL (US); Satyabrata Rout, Karnataka (IN)

(21) Appl. No.: 14/704,001

(22) Filed: May 5, 2015

(51) Int. Cl. G06F 3/16; H04L 29/08; H04M 1/725

(52) U.S. Cl. CPC G06F 3/167; H04M 1/72522; H04L 67/06

(57) ABSTRACT

A method and apparatus for voice operation of mobile applications having unnamed view elements includes an electronic computing device configured to determine that a view element for a mobile application is unnamed in a view hierarchy layout file for the mobile application and to enter a name for the view element in a data record. The method performed by the electronic computing device further includes receiving a voice command for an operation that invokes the view element. Additionally included in the method is determining, using the name for the view element, display coordinates for the view element and actuating the view element using the display coordinates.

### FIELD OF THE DISCLOSURE

The present disclosure relates generally to voice operation of application software and more particularly to voice operation of mobile applications having unnamed view elements.

### BACKGROUND

As electronic computing devices have decreased in form factor while increasing in functionality, traditional input peripherals, such as keyboards and mice, have been increasingly abandoned in favor of direct input means, such as touch. This is especially true of mobile devices. With tactile input, users can interact with viewable elements, such as virtual buttons, switches, and slides, rendered on a touchscreen of a mobile device.

Currently, as processor power continues to evolve in accordance with Moore's law, significant advancements are being made in the area of voice recognition. Mobile devices are improving in their ability to quickly and accurately process speech. Voice recognition replacing or supplementing touch as a means of input for mobile devices has certain benefits. Voice operation, for example, frees a user's hands to perform other tasks. Additionally, smaller mobile devices, such as wrist-worn mobile devices, can be too small to effectively operate using touch.

A difficulty encountered with voice input is that while hardware might be voice capable, software is often not. For example, although voice capability could be useful, popular mobile applications developed by third parties for mobile devices are often developed without voice capability.

### BRIEF DESCRIPTION OF THE FIGURES

The accompanying figures, where like reference numerals refer to identical or functionally similar elements throughout the separate views, form part of the specification and illustrate embodiments in accordance with the included claims.

FIG. 1 shows a block diagram of an electronic computing device, in accordance with some embodiments.

FIG. 2 shows a mobile device, in accordance with some embodiments.

FIG. 3 shows a screen capture for a mobile device, in accordance with some embodiments.

FIG. 4 shows a portion of a view hierarchy layout file for a mobile application, in accordance with some embodiments.

FIG. 5 shows a screen capture for a mobile device, in accordance with some embodiments.

FIG. 6 shows a portion of a view hierarchy layout file for a mobile application, in accordance with some embodiments.

FIG. 7 shows a screen capture for a mobile device, in accordance with some embodiments.

FIG. 8 shows a portion of a view hierarchy layout file for a mobile application, in accordance with some embodiments.

FIG. 9 shows variations of a voice command for an operation that invokes view elements, in accordance with some embodiments.

FIG. 10 shows a state diagram for voice operation of a mobile application, in accordance with some embodiments.

FIG. 11 shows a portion of voice command sequence file for voice operation of a mobile application, in accordance with some embodiments.

FIG. 12 shows a portion of voice command sequence file for voice operation of a mobile application, in accordance with some embodiments.

FIG. 13 shows a portion of a view hierarchy layout file for a mobile application which includes unnamed view elements, in accordance with some embodiments.

FIG. 14 shows a portion of a view hierarchy layout file for a mobile application which includes unnamed view elements, in accordance with some embodiments.

FIG. 15 shows a portion of a view hierarchy layout file for a mobile application which includes unnamed view elements, in accordance with some embodiments.

FIG. 16 shows a portion of a voice command sequence file for voice operation of a mobile application, in accordance with some embodiments.

FIG. 17 shows a portion of a voice command sequence file for voice operation of a mobile application, in accordance with some embodiments.

FIG. 18 shows a logical flow diagram illustrating a method for enabling voice operation of a mobile application having an unnamed view element, in accordance with some embodiments.

FIG. 19 shows a server device, in accordance with some embodiments.

FIG. 20 shows a logical flow diagram illustrating a method for enabling voice operation of a mobile application having an unnamed view element, in accordance with some embodiments.

FIG. 21 shows a logical flow diagram illustrating a method for acquiring locale-specific view element names, in accordance with some embodiments.

FIG. 22 shows a logical flow diagram illustrating a method for ranking help files, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present teachings. In addition, the description and drawings do not necessarily require the order presented. It will be further appreciated that certain actions and/or steps may be described or depicted in a particular order of occurrence while those skilled in the art will understand that such specificity with respect to sequence is not actually required.

The apparatus and method components have been represented, where appropriate, by conventional symbols in the drawings, showing only those specific details that are pertinent to understanding the embodiments of the present teachings so as not to obscure the disclosure with details that will be readily apparent to those of ordinary skill in the art having the benefit of the description herein.

### DETAILED DESCRIPTION

Generally speaking, pursuant to various embodiments described herein, the present disclosure provides a method and apparatus for enabling voice operation of mobile applications having unnamed view elements. More specifically, a method and apparatus is presented whereby a mobile application having unnamed view elements operates in response to voice commands that invoke the unnamed view elements.

In accordance with the teachings herein, a method performed by a mobile device for enabling voice operation of mobile applications having unnamed view elements includes determining that a view element for a mobile application is unnamed in a view hierarchy layout file for the mobile application and entering a name for the view element in a data record. The method further includes receiving a voice command for an operation that invokes the view element. Additionally, the method includes determining, using the name for the view element, display coordinates for the view element and actuating the view element using the display coordinates.

Further in accordance with the teachings herein, a method performed by an electronic computing device for enabling voice operation of mobile applications having unnamed view elements includes determining that a view element for a mobile application is unnamed in a view hierarchy layout file for the mobile application and entering a name for the view element in a data record. The method also includes entering the name for the view element in a voice command sequence file for a voice command for an operation that invokes the view element and uploading the data record and the voice command sequence file to a fileserver.

In a particular embodiment, the electronic computing device is a mobile device, and the method further includes receiving a voice command for an operation that invokes the view element and determining, using the name for the view element, display coordinates for the view element. The method also includes actuating the view element using the display coordinates.

Also in accordance with the teachings herein is a mobile device configured to enable voice operation of mobile applications having unnamed view elements that includes a display configured to render view elements and a microphone configured to receive a voice command that invokes a view element for a mobile application. The mobile device additionally includes a processing element, operatively coupled to the display and the microphone, that is configured to determine that the view element is unnamed in a view hierarchy layout file for the mobile application and to enter a name for the view element in a data record. The processing element is further configured to determine, using the name for the view element, display coordinates for the view element and to actuate the view element using the display coordinates.

For a particular embodiment, the mobile device further includes a communication interface operatively coupled to the processing element, wherein communication interface is configured to communicate with other electronic devices. The processing element is additionally configured to enter the name for the view element in a voice command sequence file for the voice command and also upload the data record and the voice command sequence file to a fileserver using the communication interface.

An electronic computing device, also referred to simply as an electronic device, is any device configured to enable voice operation of a mobile application as described herein. This includes both electronic devices that execute mobile applications, at least in part, with voice input and also electronic devices that contribute to the voice operation of mobile applications by other electronic devices. A non-exhaustive list of electronic devices consistent with described embodiments includes smartphones, phablets, tablets, personal digital assistants (PDAs), enterprise digital assistants (EDAs), television interfacing devices, such as media streaming devices, laptops, personal computers (PCs), workstations, and servers.

A mobile application, as used herein, refers to a software program developed with the ability to execute on a mobile device or an electronic computing device running an operating system that is configured, at least in part, to run on a mobile device. A mobile device, as used herein, refers to a portable electronic computing device. WhatsApp is an example of a mobile application. Specifically, WhatsApp is a cross-platform mobile messaging application. An iPhone running the iOS mobile operating system can execute WhatsApp. WhatsApp is also executable on television media streaming devices running the Android mobile operating system. Additional examples of mobile applications to which the present teachings are applicable include Instagram, Twitter, Snapchat, Skype, Pandora, or any other mobile application designed to accept user input.

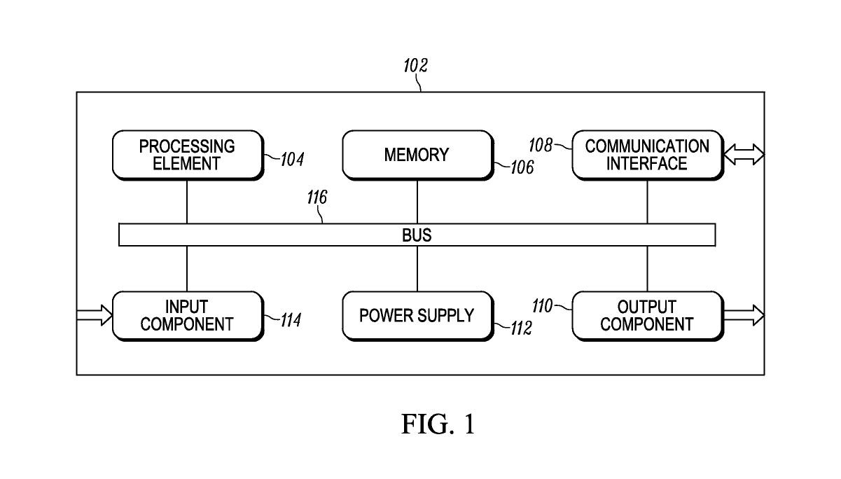

FIG. 1 shows a block diagram 102 of an electronic computing device in accordance with some embodiments of the present teachings. Included within the block diagram 102 is a processing element 104, memory 106, a communication interface 108, an input component 114, an output component 110, and a power supply 112, which are all operationally interconnected by a bus 116. A limited number of device components 104, 106, 108, 110, 112, 114, and 116 are shown at 102 for ease of illustration. Other embodiments may include a lesser or greater number of components in an electronic computing device. Moreover, other components needed for a commercial embodiment of an electronic computing device that incorporates the components 104, 106, 108, 110, 112, 114, 116 shown at 102 are omitted from FIG. 1 for clarity in describing the enclosed embodiments.

In general, the processing element 104 is configured with functionality in accordance with embodiments of the present disclosure as described herein with respect to the remaining figures. “Configured,” “adapted,” “operative,” or “capable,” as used herein, means that indicated components are implemented using one or more hardware elements, such as one or more operatively coupled processing cores, memory elements, and interfaces, which may or may not be programmed with software and/or firmware, as the means for the indicated components to implement their desired functionality. Such functionality is supported by the other hardware shown in FIG. 1, including the device components 106, 108, 110, 112, and 114, which are all operatively interconnected with the processing element 104 by the bus 116.

The processing element 104, for instance, includes arithmetic logic and control circuitry necessary to perform the digital processing, in whole or in part, for the electronic computing device 102 to enable voice operation of mobile applications having unnamed view elements in accordance with described embodiments for the present teachings. For one embodiment, the processing element 104 represents a primary microprocessor, also referred to as a central processing unit (CPU), of the electronic computing device 102. For example, the processing element 104 can represent an application processor of a tablet. In another embodiment, the processing element 104 is an ancillary processor, separate from the CPU, wherein the ancillary processor is dedicated to providing the processing capability, in whole or in part, needed for the components of the electronic computing device 102 to perform at least some of their intended functionality. For one embodiment, the ancillary processor is a graphical processing unit (GPU) for an electronic device having a display screen.

The memory 106 provides storage of electronic data used by the processing element 104 in performing its functionality. For example, the processing element 104 can use the memory 106 to store files associated with the voice operation mobile applications. In one embodiment, the memory 106 represents random access memory (RAM). In other embodiments, the memory 106 represents volatile or non-volatile memory. For a particular embodiment, a portion of the memory 106 is removable. For example, the processing element 104 can use RAM to cache data while it uses a micro secure digital (microSD) card to store files associated with the voice operation of a mobile application.

The communication interface 108 allows for communication between the electronic computing device 102 and other electronic devices, such as mobile devices or file servers, configured to support the electronic computing device 102 in performing its described functionality. For one embodiment, the communication interface 108 uses a cellular transceiver to enable the electronic computing device 102 to communicate with other electronic devices using one or more cellular networks. Cellular networks can use any wireless technology that, for example, enables broadband and Internet Protocol (IP) communications including, but not limited to, 3^{rd} Generation (3G) wireless technologies such as CDMA2000 and Universal Mobile Telecommunications System (UMTS) networks or 4^{th} Generation (4G) wireless networks such as LTE and WiMAX.

In another embodiment, the communication interface 108 uses a wireless local area network (WLAN) transceiver that allows the electronic computing device 102 to access the Internet using standards such as Wi-Fi. The WLAN transceiver allows the electronic computing device 102 to send and receive radio signals to and from similarly equipped electronic devices using a wireless distribution method, such as a spread-spectrum or orthogonal frequency-division multiplexing (OFDM) method. For some embodiments, the WLAN transceiver uses an IEEE 802.11 standard to communicate with other electronic devices in the 2.4, 3.6, 5, and 60 GHz frequency bands. In a particular embodiment, the WLAN transceiver uses Wi-Fi interoperability standards as specified by the Wi-Fi Alliance to communicate with other Wi-Fi certified devices.

For additional embodiments, the communication interface 108 uses hard-wired, rather than wireless, connections to a network infrastructure that allows the electronic computing device 102 to communicate electronically with other devices. For example, the communication interface 108 includes a socket that accepts an RJ45 modular connector which allows the electronic computing device 102 to be connected directly to a network router by category-5 or category-6 Ethernet patch cable. The communication interface 108 can also use a cable modem or a digital subscriber line (DSL) to connect with other electronic devices through the Internet via an internet service provider (ISP).

The input component 114 and the output component 110 represent user-interface components of the electronic computing device 102 configured to allow a person to use, program, or otherwise interact with the electronic computing device 102. Different electronic computing devices for different embodiments include different combinations of input 114 and output 110 components. A touchscreen, for example, functions both as an output component and an input component for some embodiments by allowing a user to see displayed view elements for a mobile application and to actuate the view elements by tapping on them. Peripheral devices for other embodiments, such as keyboards, mice, and touchpads, represent input components that enable a user to program a PC or server to enable voice operation of mobile applications having unnamed view elements. A speaker is an output component 110 that for some embodiments allows an electronic computing device to verbally prompt a user for input. Particular embodiments include an acoustic transducer, such as a microphone, as an input component that converts received acoustic signals into electronic signals, which can be encoded, stored, and processed for voice recognition.

Electronic computing devices that include a microphone might also include a voice recognition module (not shown), which includes hardware and software elements needed to process voice data by recognizing words. Processing voice data includes identifying commands from speech. This type of processing is used, for example, when one wishes to give a verbal instruction or command to operate a mobile application. For different embodiments, the voice recognition module can include a single or multiple voice recognition engines of varying types, each of which is best suited for a particular task or set of conditions, such as for specific characteristics of a voice or noise conditions. The voice recognition module might also include a voice activity detector (VAD), which allows the electronic computing device to discriminate between those portions of a received acoustic signal that include speech and those portions that do not. In voice recognition, the VAD is used to facilitate speech processing, obtain isolated noise samples, and to suppress non-speech portions of acoustic signals.

The power supply 112 represents a power source that supplies electric power to the device components 104, 106, 108, 110, 114, 116, as needed, during the course of their normal operation. The power is supplied to meet the individual voltage and load requirements of the device components 104, 106, 108, 110, 114, 116 that draw electric current. For some embodiments, the power supply 112 is a wired power supply that provides direct current from alternating current using a full- or half-wave rectifier. For other embodiments, the power supply 112 is a battery that powers up and runs a mobile device. For a particular embodiment, the battery 112 is a rechargeable power source. A rechargeable power source for a device is configured to be temporarily connected to another power source external to the device to restore a charge of the rechargeable power source when it is depleted or less than fully charged. In another embodiment, the battery is simply replaced when it no longer holds sufficient charge.

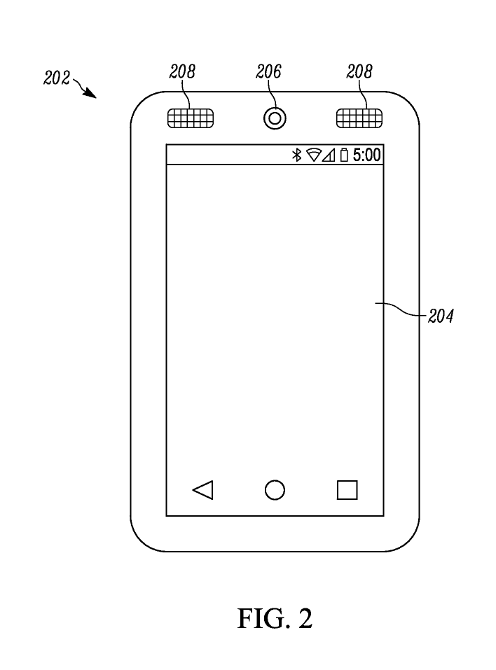

FIG. 2 shows a mobile device 202, in particular, a smartphone, which for described embodiments is taken to be the electronic computing device shown schematically by the block diagram 102. The mobile device 202 includes a touchscreen 204, also referred to as a display, a microphone 206, and stereo speakers 208, which collectively represent the input 114 and output 110 components indicated in the block diagram 102. The remaining components 104, 106, 108, 112, 116 are also included in the mobile device 202 but not explicitly indicated in FIG. 2.

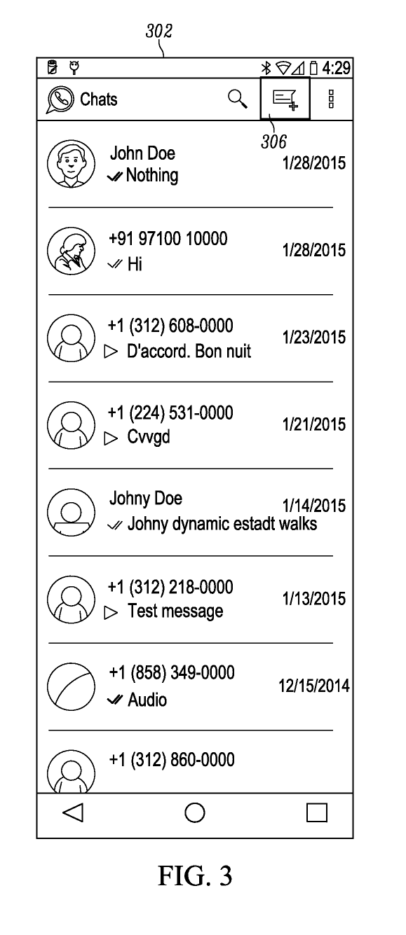

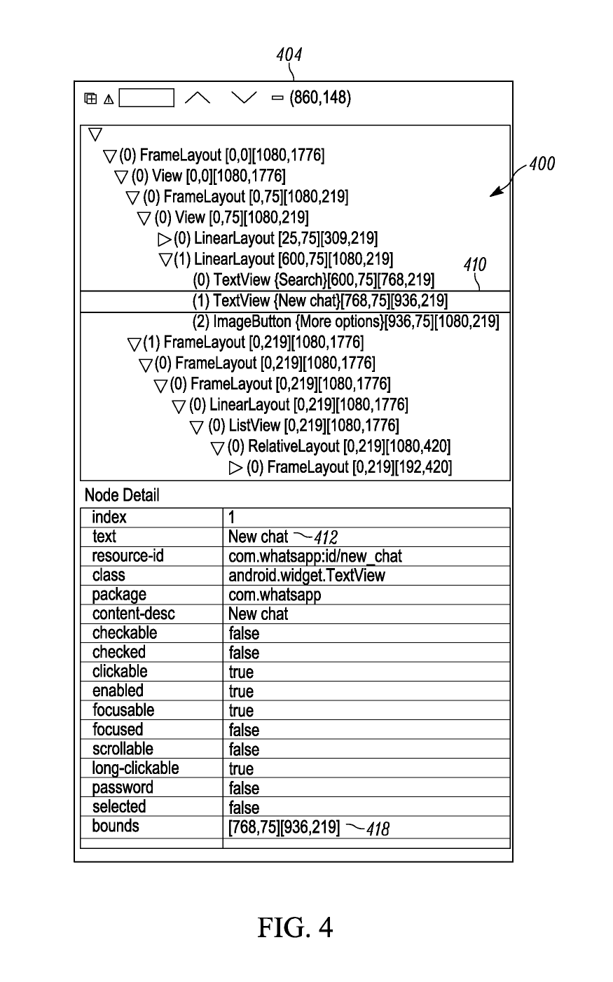

FIGS. 3, 5, and 7 show screen captures 302, 502, 702, also referred to herein simply as screens, of the touchscreen 204 for the mobile device 202 executing a mobile application. FIGS. 4, 6, and 8 show accompanying portions of a view hierarchy layout file 400 for the mobile application as snapshots 404, 604, 804, respectively. The mobile application chosen for illustrative and explanatory purposes is WhatsApp, but in practice, no limitation as to the types of mobile applications to which the present teachings apply is stated or implied.

The different screen captures 302, 502, 702 capture different user interfaces with which a user can interact to perform different operations. In accordance with described embodiments, mobile devices present viewable screens with the support of operating systems that use view hierarchy layout files to control the graphical presentation of content. A view hierarchy layout file for a mobile application serves as a type of “blueprint” for how a mobile device renders the viewable screens of the mobile application on a display for the mobile device. For purposes of the present disclosure, a view hierarchy layout file for a mobile application is any electronic file that identifies one or more graphical view elements, referred to herein simply as “view elements,” for the mobile application and that includes information on how the view elements are rendered on a display of a mobile device.

FIG. 3 shows the screen capture 302 for WhatsApp executing on the mobile device 202. Visible in the screen capture 302 are view elements which collectively define the overall appearance of the screen 302. View elements are icons or graphical constructs rendered on a display of a mobile device to which individual properties, appearance, or functionality can be assigned. A view element might change its appearance or position, for example, its color or shape, to indicate a condition or state, such as a low charge or incoming message. View elements also provide a means by which a user can interact with a mobile application. A view element might present as a virtual button, knob, slider, or switch which the user can manipulate. For example, from the screen 302, a user could tap on a highlighted view element 306 to start a new chat.

FIG. 4 shows the snapshot 404 of the accompanying portion of the view hierarchy layout file 400 for the WhatsApp mobile application. This portion of the view hierarchy layout file 400 for WhatsApp is associated with the screen 302, also referred to as the new-chat screen, in that the mobile device 202 uses the information shown in the snapshot 404 to render the screen 302. A highlighted line entry 410 corresponds to the view element 306 and includes a name for the view element 306 specified as “new chat.” The name is also indicated at 412 in a node-detail view for the highlighted view element 306. A name for a view element is a tag or reference that allows the view element to be uniquely identified and distinguished from other view elements.

The line entry 410 additionally includes two sets of display coordinates, [768, 75] and [936, 219], which are additionally indicated at 418 in the node-detail view for the view element 306. The display coordinates define an upper-left corner and a lower-right corner, respectively, of a rectangular area identifiable with the new-chat view element 306. If the mobile device 202 detects contact within this rectangular area of its touchscreen 204, then the contact is processed as a tap on the new-chat view element 306. As shown, the display coordinates for the new-chat view element 306 appear as Cartesian coordinates. In different embodiments, other coordinate systems are used for display coordinates that indicate the position and extent or where and how view elements are rendered on a display. For example, an ordered pair of coordinates might define the center position of a view element rendered on a display and a radius might define the extent of the view element. A tap anywhere within the radius of the center is, thereby, processed as a tap on the view element.

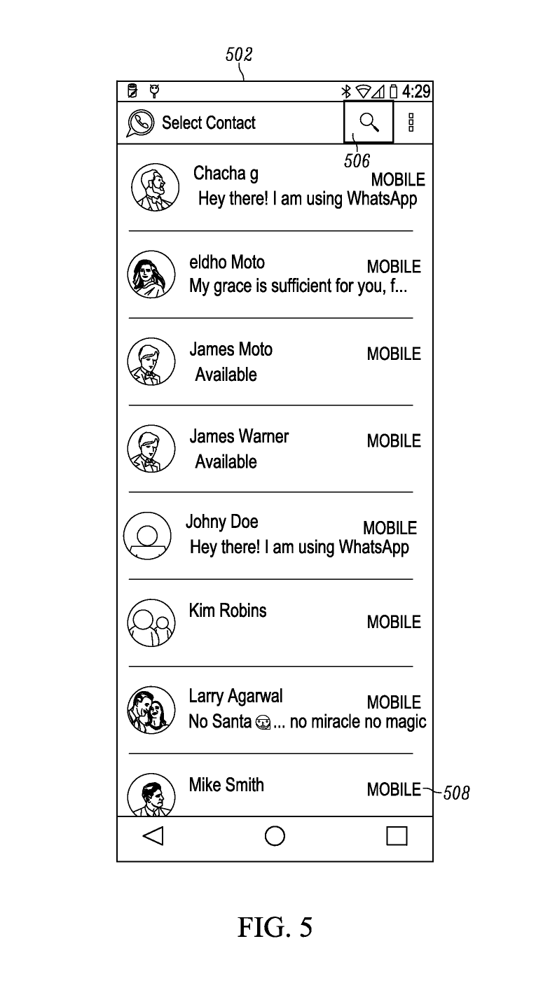

Tapping on the new-chat view element 306 brings up the second screen 502 for WhatsApp shown in FIG. 5. This screen 502, also referred to as the search screen, allows the user to search for a contact to message. By tapping on a view element 506, the user can bring up a fill-contact screen (not shown) to populate with the name of the contact he wishes to message. Alternatively, the user can tap on a view element to select a contact. By tapping on a view element 508, for example, the user selects a contact Mike Smith to message.

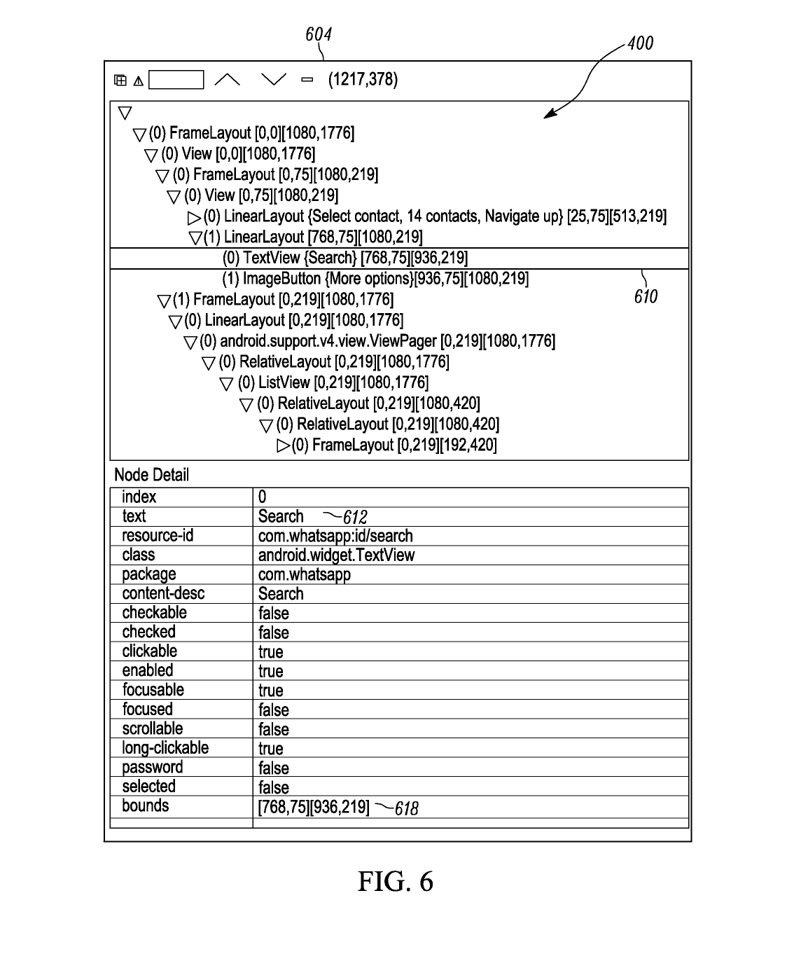

A name “search” by which to identify the view element 506 is included in a portion of the view hierarchy layout file 400 shown by snapshot 604 in FIG. 6. This portion of the view hierarchy layout file 400 is associated with the screen 502. The name “search” is explicitly indicated in a highlighted line entry 610 for the view hierarchy layout file 400, and also appears at 612 in a node-detail view for the highlighted view element 506. The line entry 610 additionally includes display coordinates that define spatial bounds for the search view element 506 on the touchscreen 204 of the mobile device 202. These display coordinates are also indicated at 618 in the node-detail view for the view element 506.

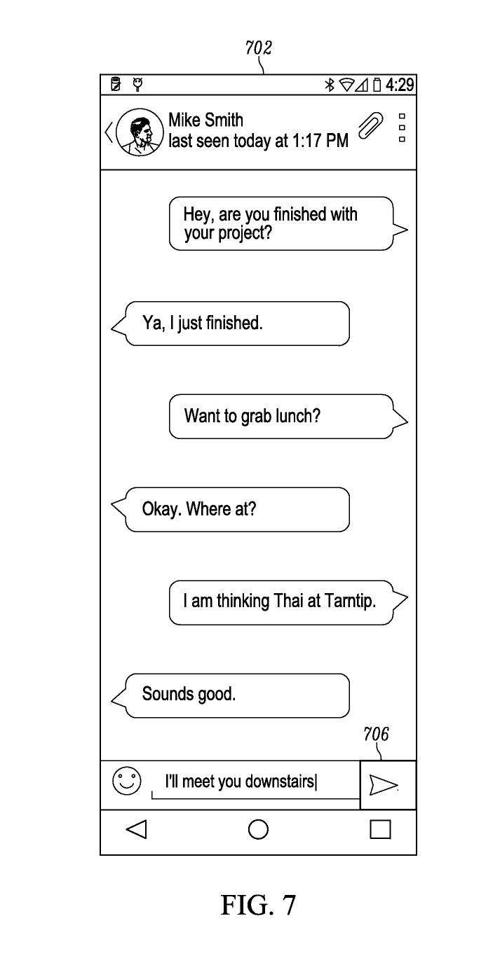

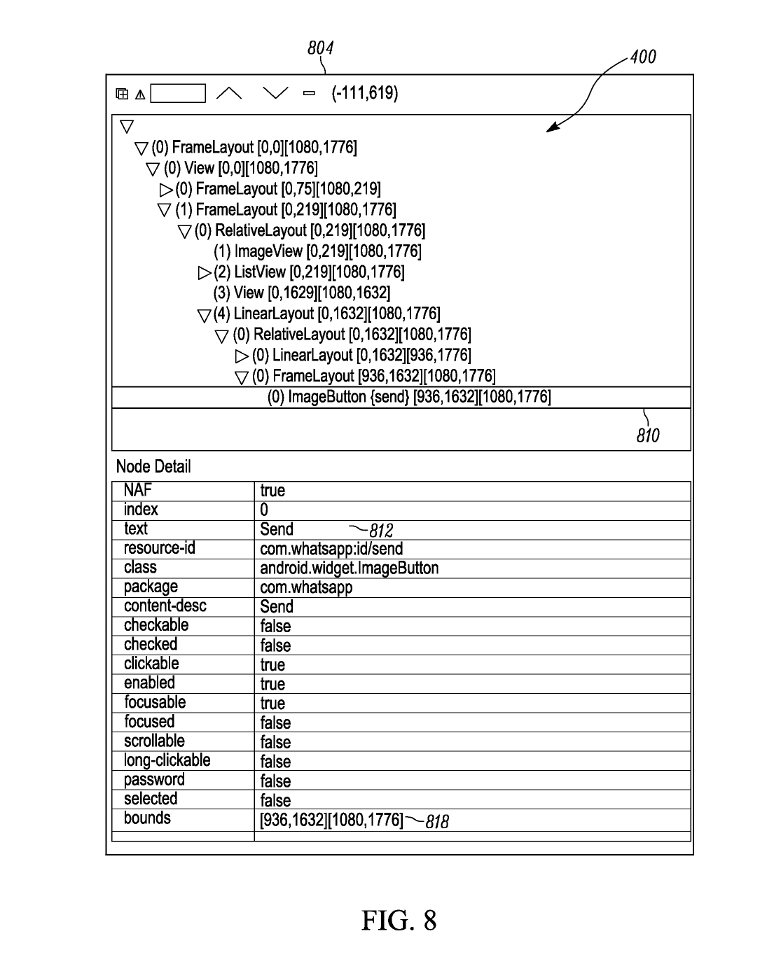

FIG. 7 shows the screen 702 from which the user can tap a view element 706 to send a short message service (SMS) text message he has composed. An accompanying third portion of the view hierarchy layout file 400 is shown in FIG. 8 by the snapshot 804. A line entry 810 indicates “send” as the name of the view element 706. The name appears again at 812 in a node-detail view for the view element 706. The node-detail view of the view element 706 also indicates at 818 display coordinates, for the view element 706, which are also included in the line entry 810.

The first 302, second 502, and third 702 screens shown in FIGS. 3, 5, and 7, respectively, represent three of a plurality of screens presented to a user sending a text message with WhatsApp. The user navigates the process of sending the text message, or performing other operations, by tactile manipulation of specific view elements appearing on displayed screens in a particular sequence. As the present disclosure concerns the voice operation of mobile applications, individual view elements are manipulated or actuated herein by voice command.

For an embodiment, voice commands are received by the microphone 206 for the mobile device 202 as an acoustic signal that includes a speech signal. The acoustic signal is processed by a voice recognition module that includes a VAD. The VAD applies a trigger for phoneme detection to the acoustic signal and detects the speech signal when sufficient conditions are met to overcome a phoneme detection trigger threshold. The mobile device 202 uses the phoneme detection trigger to differentiate between speech and other sounds. When the phoneme detection trigger is “tripped,” the mobile device 202 operates under the supposition that a user is speaking. The mobile device 202 uses phonemes as an indicator for the presence of speech because phonemes are the smallest contrastive unit of a language's phonology. They are the basic sounds a speaker makes while speaking Potential phonemes isolated from the acoustic signal are compared to spectral patterns for phonemes stored in a library database. This database, and any other databases used by the mobile device 202 in connection with speech recognition, can be stored locally, such as in memory 106, or stored remotely and accessed using the communication interface 108.

When a person is speaking, the mobile device 202 attempts to match phonemes in the speech signal to phrases using a phrase matching trigger. A phrase is a recognizable word, group of words, or utterance that has operational significance with respect to the mobile device 202 or a mobile application executing on the mobile device 202. For command recognition, the trigger condition for phrase matching is a match between phonemes received and identified in the speech signal to phonemes stored as reference data for a programmed command. When a match occurs, the mobile device 202 processes the command represented by the phonemes. What constitutes a match is determined by a trigger threshold for phrase matching. For an embodiment, a match occurs when a statistical confidence score calculated for received phonemes exceeds a value set as the trigger threshold for phrase matching. The trigger's threshold or sensitivity is the minimum degree to which a spoken phrase must match a programmed command before the command is registered. Words not recognized as preprogrammed commands, that may instead be part of a casual conversation, are ignored.

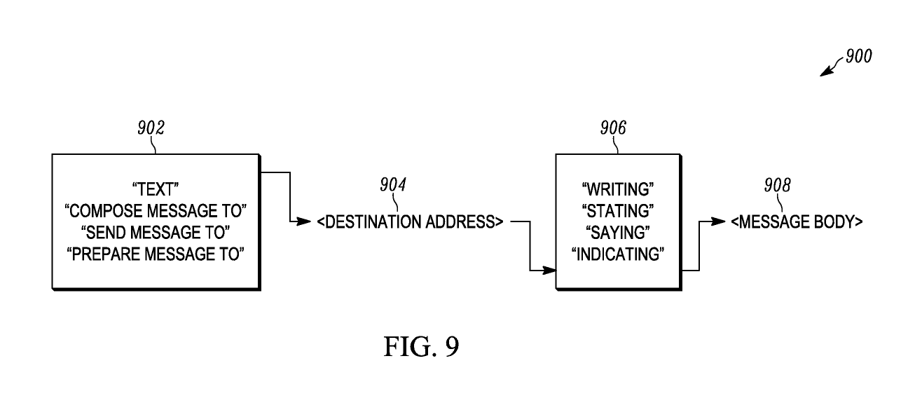

FIG. 9 shows sixteen phrases accepted by the mobile device 202 in an embodiment as a voice command 900 for sending a text message. The command 900 is shown in four parts. A first part 902 indicates a text message is being sent. A second part 904 indicates a destination address for the text message for a contact who will be receiving the text message. A third part 906 indicates a message body is to follow, and a final part 908 is a recitation of the message body.

For the first part 902 of the command 900, the mobile device 202 recognizes four phrases, “text,” “compose message to,” “send message to,” and “prepare message to.” The detection of any of these phrases results in an application manager for the mobile device 202 launching a default text messaging application. If no default application is specified, the mobile device 202 may prompt the user to indicate a text messaging application.

For the third part 906 of the command 900, the mobile device 202 again recognizes four phrases, specifically “writing,” “stating,” “saying,” and “indicating.” Given all possible combinations of the first part 902 and the third part 906 of the command 900, sixteen phrasings of the command 900 are accepted by the mobile device 202. A user speaking “text Mike Smith indicating I'll meet you downstairs” or the user speaking “send a message to Mike Smith saying I'll meet you downstairs” both result in the same text message being sent to Mike Smith.

In some embodiments, the mobile device 202 recognizes additional phrasings of the text-message command 900 through the use of a dictionary or thesaurus file or database. For example, the user utters the phrase “typing” for the third part 906 of the command 900, which does not match any of the four indicated phrases “writing,” “stating,” “saying,” or “indicating.” The mobile device 202 then references an electronic dictionary or definition database to determine that the definition of the word “typing” is sufficiently similar to the word “writing” to accept the spoken command 900. The substitution of the word “typing” for the word “writing” might also result in the mobile device 202 accepting the command 900 if in referencing a thesaurus file or database the mobile device 202 determines an equivalence exists between the two words.

In further embodiments, the mobile device 202 also accepts different permutations for commands. This works by the mobile device 202 associating identified phrases with specific parts of a command, irrespective of the order in which the phrases are uttered. For example, a first permutation is: “Send message to Mike Smith and write I'll meet you downstairs,” and a second permutation is: “Write I'll meet you downstairs and send message to Mike Smith.” Both permutations result in the same text message being sent to the same recipient. For both permutations, the destination address 904 is prefaced with what the mobile device 202 identifies as the first part of the command 902, and the message body 908 is prefaced with what the mobile device 202 identifies as the third part 906 of the command. The mobile device 202, in some instances, disregards the conjunction “and.”

For a plurality of embodiments, voice commands the mobile device 202 is programmed to recognize are stored in a data structure, or combination of data structures, such as a voice command table. These data structures map voice commands to sets of operations the mobile device 202 performs upon receiving the voice commands. As used herein, a set may include only a single element or multiple elements. In one embodiment, a voice command table stored on the mobile device 202 maps the voice command 900 to a set of programmed operations with each operation taking the mobile device 202 from one state to another. These states and accompanying operations are stored in a voice command sequence file for the voice command 900.

A voice command sequence file, as used herein, is a data structure, or combination of data structures, which stores instructions for actuating a sequence of view elements to take a mobile device from at least one state to another state in response to receiving a voice command. Actuating a view element means activating, initiating, or commencing an action that user interaction with the view element is designed or programmed to bring about. If, for example, tapping on a view element results in a selection screen being displayed, then actuating the view element, however it is done, results in this same action, namely the selection screen being displayed.

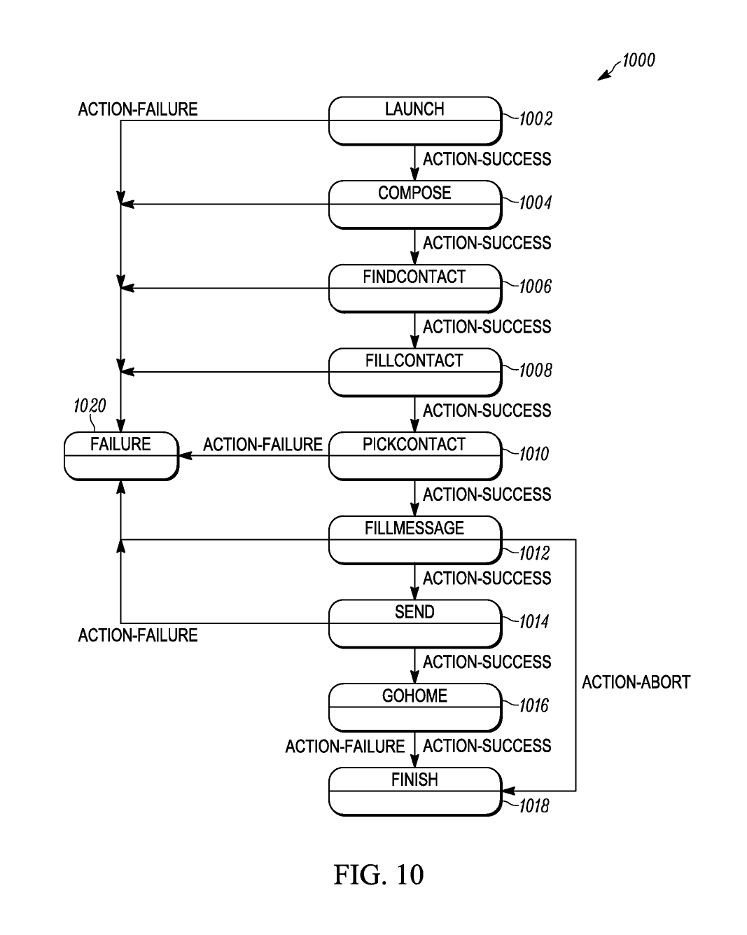

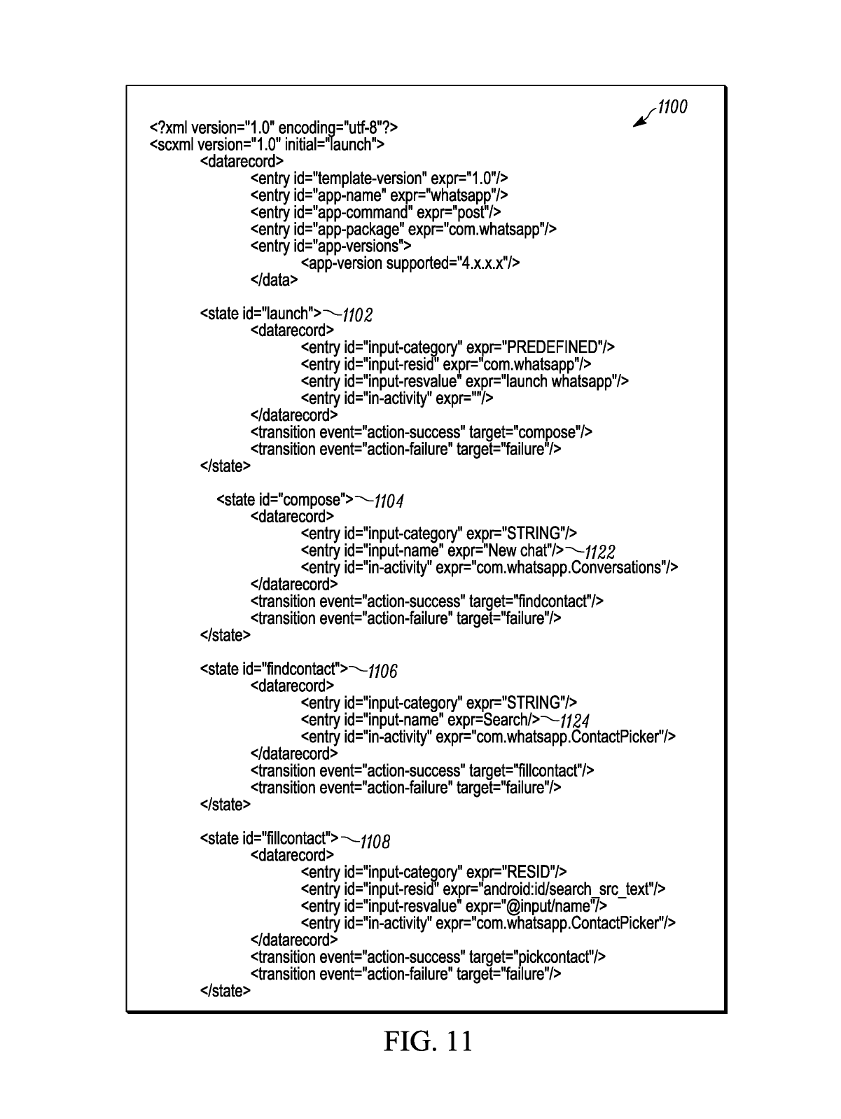

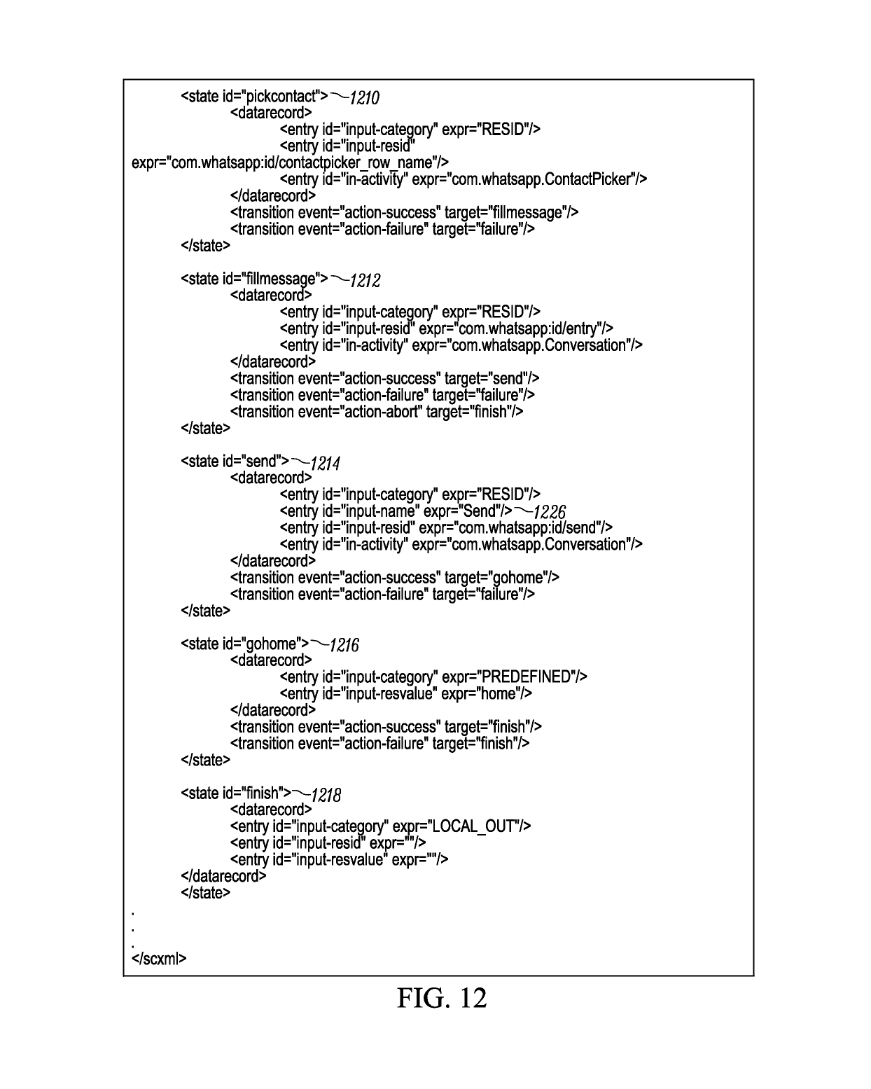

FIG. 10 describes, by means of a state diagram 1000, how the mobile device 202 responds to receiving the voice command 900 to send a text message. The mobile device 202 progresses through a same sequence of screens it would for sending a text message if a user were tapping on the touchscreen 204. A corresponding voice command sequence file 1100 for the voice command 900 is shown in FIGS. 11 and 12. When the mobile device 202 detects the voice command 900 and responsively executes the voice command sequence file 1100, it begins in a launch state 1002, 1102. From the launch state 1002, 1102, the mobile device 202 transitions to a compose state 1004, 1104 as an application manager for the mobile device 202 launches the WhatsApp mobile application.

In the compose state 1004, 1104, the screen 302 is rendered on the touchscreen 204. From here, a tactile user would tap on the new-chat view element 306 to search for a contact to message. With voice operation, however, the mobile device 202 actuates the new-chat view element 306 using the display coordinates 418 in the view hierarchy layout file 400. Accordingly, for an embodiment, actuating a view element using display coordinates includes emulating manipulation of the view element. The user speaking the voice command 900 does not contact the new-chat view element 306, but the mobile device 202 proceeds as if he had. Namely, the mobile device 202 simulates contact, a tap or touch with a stylus, for example, with the view element 306, specifically within the area of the touchscreen 204 defined by the display coordinates 418.

To enable the mobile device 202 to actuate the new-chat view element 306, the mobile device 202 first identifies the new-chat view element 306 on the touchscreen 204, and its associated coordinates 418, from the name 412 appearing for the view element 306 in the view hierarchy layout file 400. This name also appears at 1122 in the voice command sequence file 1100. As the mobile device 202 advances through the voice command sequence file 1100 in response to receiving the voice command 900, the mobile device 202 launches WhatsApp and transitions to the compose state 1004, 1104 as indicated above. Within the voice command sequence file 1100, a view element is identified for the compose state 1004, 1104 by the name “new chat,” which appears in the file 1100 as a character string 1122. The mobile device 202 then searches the view hierarchy layout file 400 for a view element currently rendered in the compose state 1004, 1104 which has the same name. After identifying the new-chat view element 306 by its matching name, the mobile device 202 actuates the view element 306.

By actuating the new-chat view element 306 through emulated manipulation, the mobile device 202 transitions to a find-contact state 1006, 1106 with the screen 502 rendered on the touchscreen 204. Normally, the user would tap on the search view element 506 to select a contact to message. With voice operation, the mobile device 202 actuates the view element 506 without the tap by means of a simulated contact to the touchscreen 204 within the area defined by the display coordinates 618. The mobile device 202 identifies the view element 506 it actuates by the name “search” 612 in the view element hierarchy file 400, which matches the character string “search” appearing in the voice command sequence file 1100 at 1124.

In response to the voice command 900, the mobile device 202 continues to advance through the states shown in the state diagram 1000 and indicated in the voice command sequence file 1100 by emulating manipulation of view elements. In a fill-contact state 1008, 1108, the mobile device 202 fills the second part of the command 900, the destination address or contact name, into a view element designed to be populated with a contact name. A pick-contact state 1010, 1210 shows the contact displayed as a view element on the touchscreen 204. With a simulated touch to the contact view element, the mobile device 202 transitions to a fill-message state 1012, 1212, for which a view element is displayed into which a text message would normally be typed. The mobile device 202 populates this view element with the fourth part of the command 908, the message body, and upon successful completion transitions to a send state 1014, 1214. If the mobile device 202 is unsuccessful in populating the view element, it can prompt the user (not shown) or transition to a failure state 1020, 1220. From the fill-message state 1012, 1212, the user can also, if he chooses, abort the text message. In this event, the mobile device 202 transitions to a finish state 1018, 1218.

In the send state 1014, 1214, the touchscreen 204 displays the screen 702. With a simulated tap on the touchscreen 204 within an area defined by the coordinates 818 for the view element 706, the mobile device 202 sends the text message. The mobile device 202 identifies the view element 706 from the name “send,” which appears in both the voice command sequence file 1100 at 1226 and in the view hierarchy layout file 400 at 812. The mobile device 202 completes executing the voice command 900 by transitioning through a go-home state 1016, 1216 to the finish state 1018, 1218. If the mobile device 202 fails to successfully advance at any point before sending the text message, then the mobile device 202 transitions to the failure state 1020. In the failure state 1020, the mobile device 202 might display an error message indicating the sending of the text message was unsuccessful.

Creating the voice command sequence file 1100 for use by the mobile device 202 allows for voice operation of the mobile device 202 to send a text message with a mobile application that is itself not configured for voice operation. In general, by creating and using multiple or comprehensive voice command sequence files, a plurality of mobile applications not developed with voice capability can, nevertheless, be voice operated. As described, names appearing in a voice command sequence file for view elements are matched to names appearing in a view hierarchy layout file for a mobile application to locate the view elements on a touchscreen by their coordinates. Simulated contact with the touchscreen at the identified coordinates actuates the view elements in a sequence specified by the voice command sequence file. For an embodiment, each sequence specified by a voice command sequence file is initiated with an associated voice command.

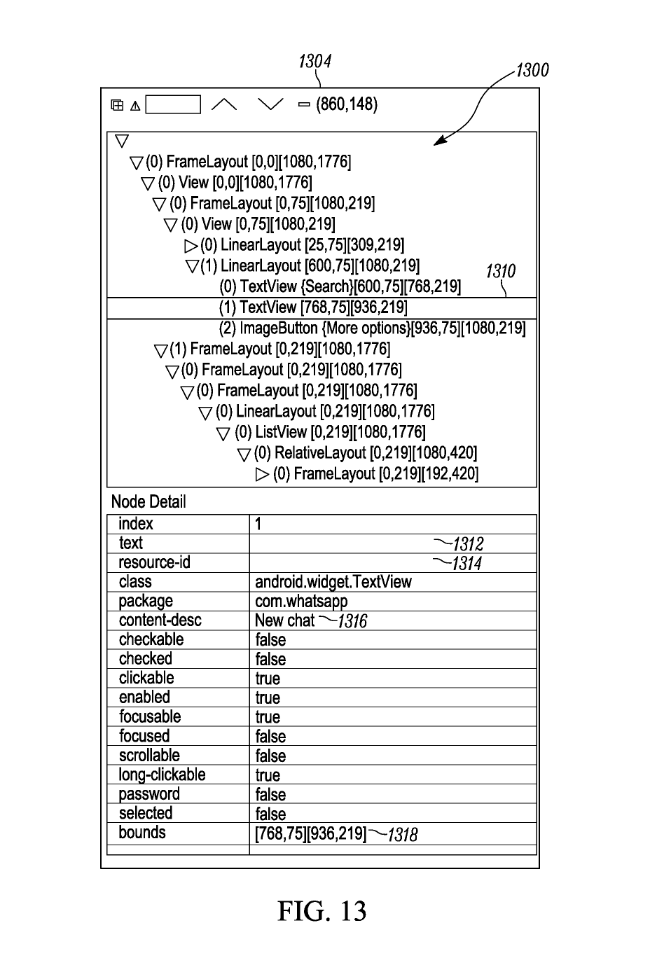

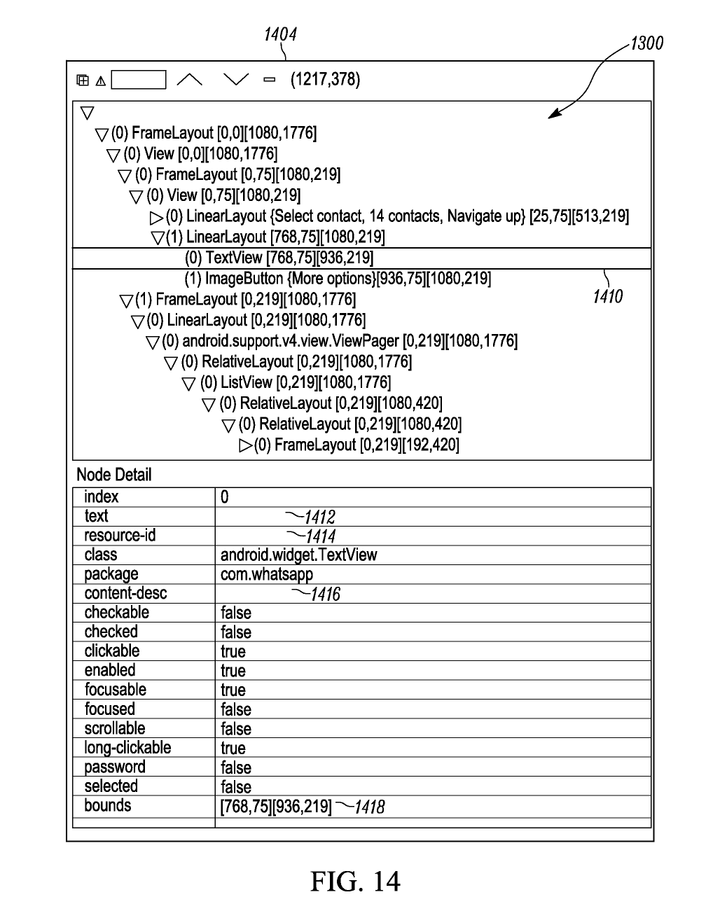

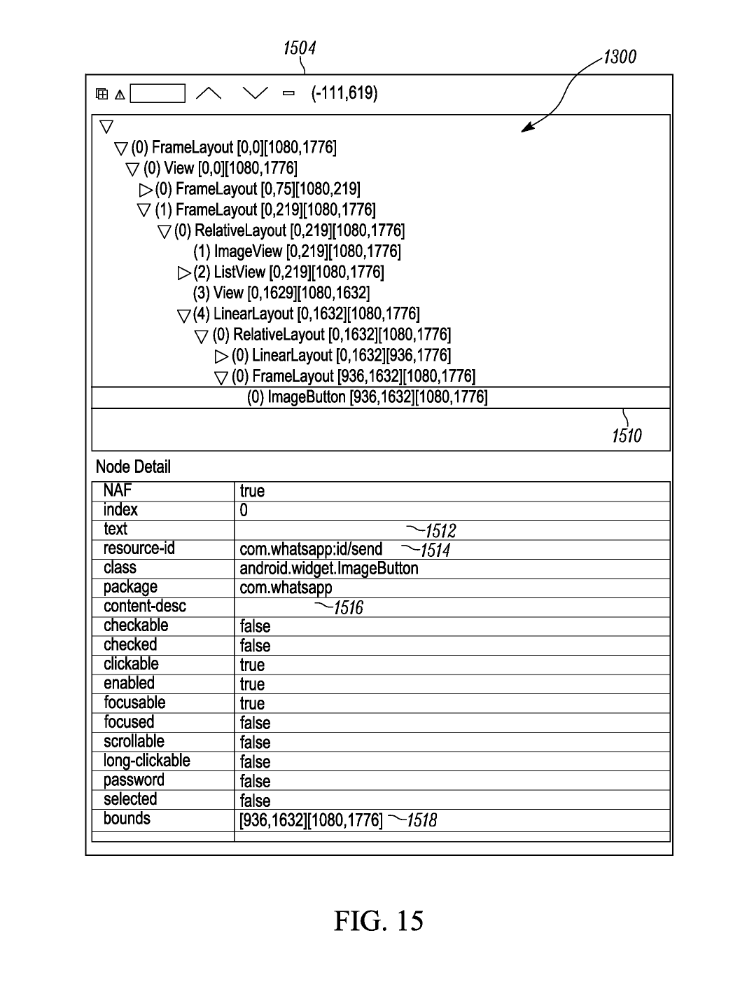

For some embodiments, one or more view elements are unnamed in a view hierarchy layout file for a mobile application. An unnamed view element, as used herein, is a view element that is not fully identified in a view hierarchy layout file. Unnamed view elements are described in more detail with reference to FIGS. 13, 14, and 15.

FIGS. 13, 14, and 15 show snapshots 1304, 1404, 1504 of a view hierarchy layout file 1300 that is the same as the view hierarchy layout file 400 shown by the snapshots 404, 604, 804, respectively, save for the fact that the view elements 306, 506, and 706 are named in the view hierarchy layout file 400 and unnamed in the view hierarchy layout file 1300. Specifically, in the snapshot 1304, a name does not appear in either a line entry 1310 for the view element 306 or at 1312 in a node-detail view for the view element 306. Similarly, a name does not appear in either a line entry 1410 for the view element 506 or at 1412 in a node-detail view for the view element 506 in the snapshot 1404. Likewise, in the snapshot 1504, a name does not appear in either a line entry 1510 for the view element 706 or at 1512 in a node-detail view for the view element 706. The line entries 1310, 1410, and 1510 only show the display coordinates, also shown in the node-detail views at 1318, 1418, and 1518, respectively, for the view elements 306, 506, and 706.

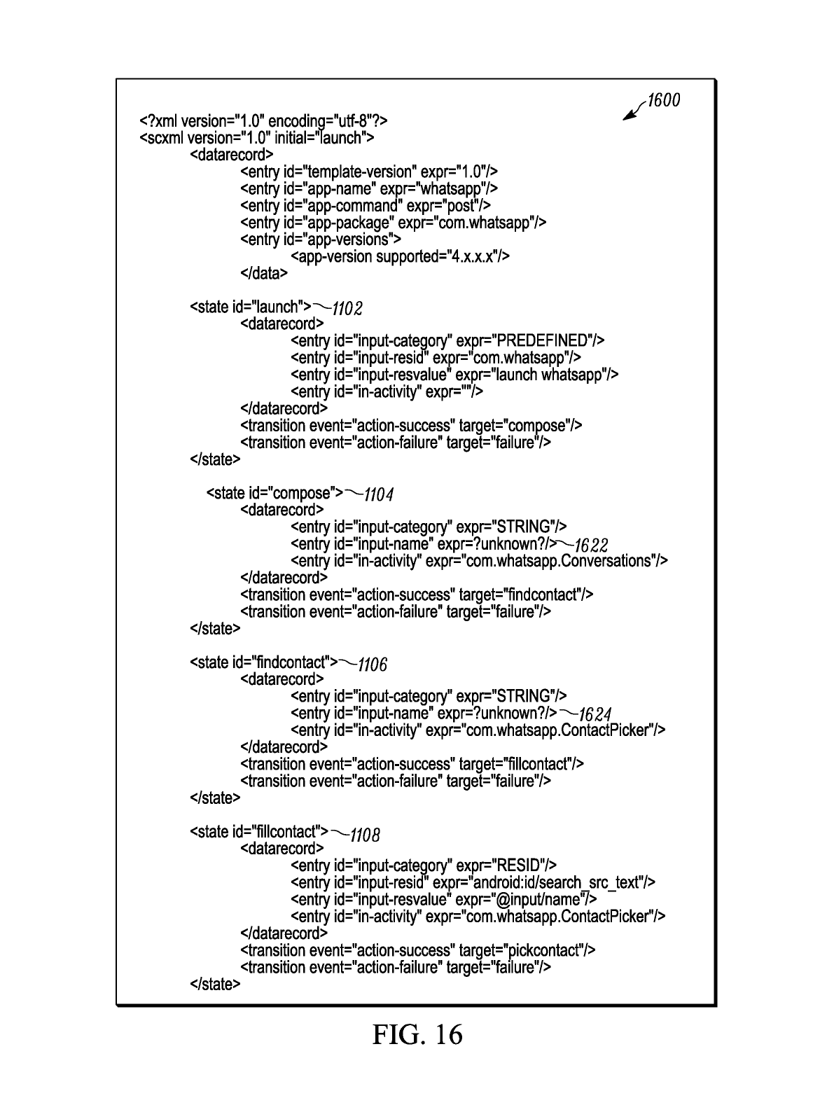

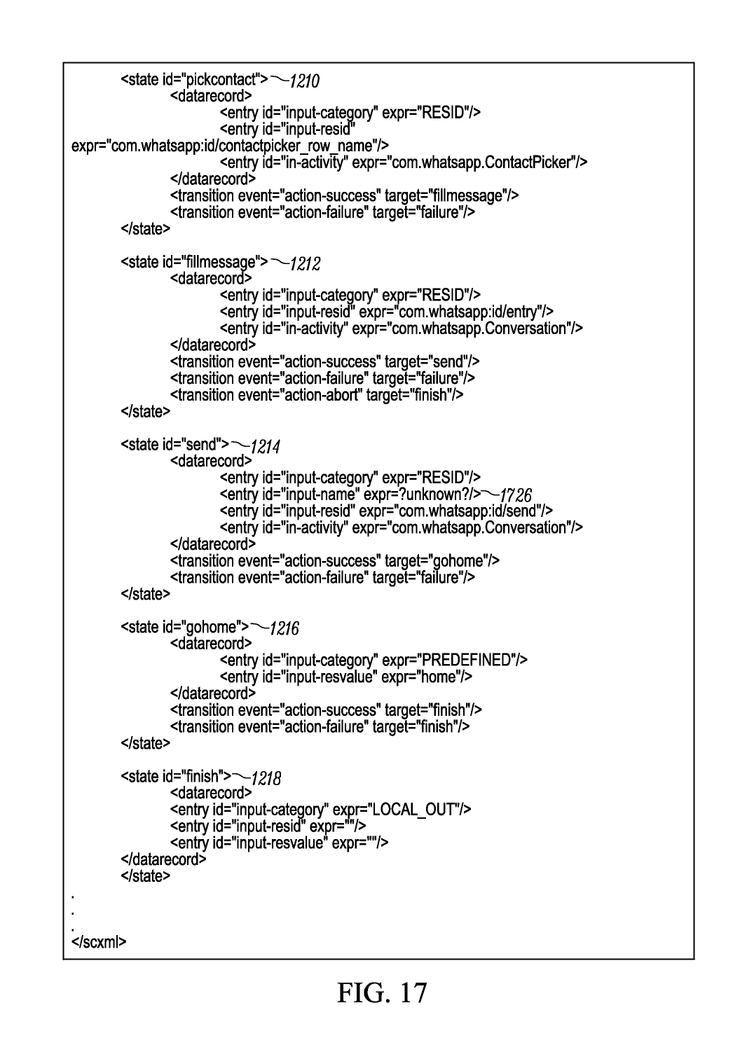

FIGS. 16 and 17 show a voice command sequence file 1600 for the voice command 900 associated with the view hierarchy layout file 1300 shown by snapshots 1304, 1404, 1504. Line entries 1622, 1624, and 1726 include character-string variables which do not indicate names for the view elements 306, 506, and 706, respectively. A method described herein for voice operation of a mobile application involving view elements unnamed in the voice command sequence file 1600 and unnamed in the view hierarchy layout file 1300 includes actions not included in the method for voice operation described with reference to the voice command sequence file 1100 and the view hierarchy layout file 400, which include only named view elements.

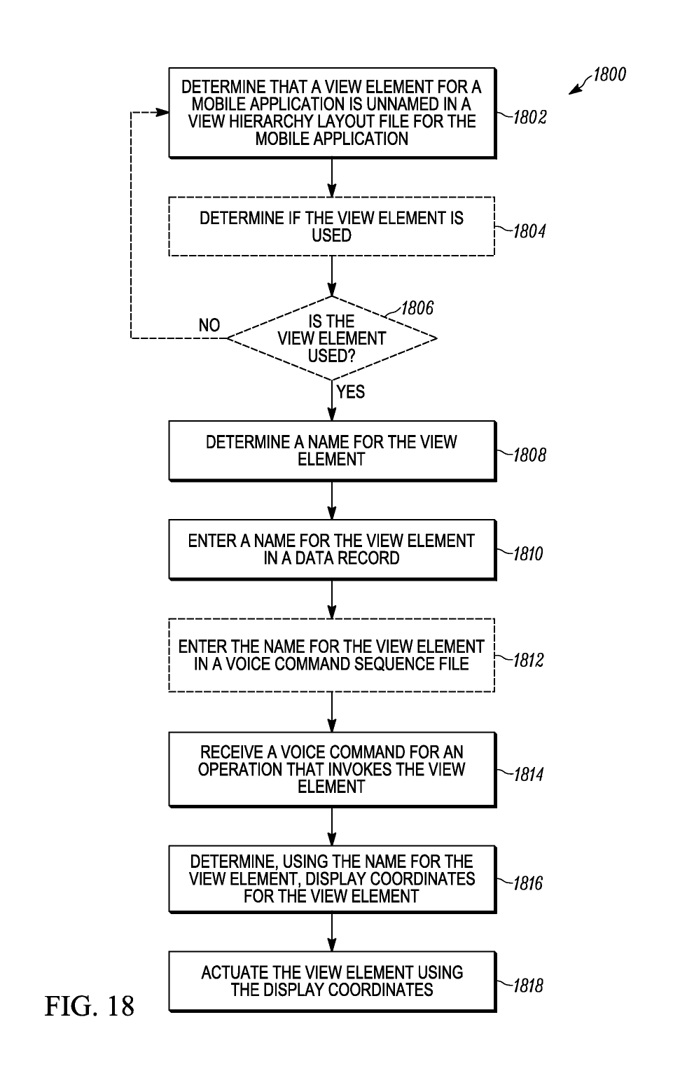

FIG. 18 shows a logical flow diagram illustrating a method 1800 for voice operation of a mobile application having one or more unnamed view elements. A detailed description of the method 1800 is given for embodiments involving the use of the mobile device 202, the voice command 900, the voice command sequence file 1600, and the view hierarchy layout file 1300. The method 1800 begins with the mobile device 202 determining 1802 that at least one view element is unnamed in the view hierarchy layout file 1300 for the WhatsApp mobile application. For an embodiment, the mobile device 202 does this by parsing the view hierarchy layout file 1300.

Parsing, as used herein, is syntactic analysis or the process of analyzing symbolic strings for an electronic file written in a particular language, whether that language is a natural language or a computer language. An unnamed view element is indicated, for example, when parsing the view hierarchy layout file 1300 reveals that no characters appear at 1312, where the view element 306 would otherwise be named. In another embodiment, a view element is unnamed when it is not uniquely identified by a name. For example, when an identical character strings appears as a name for two different view elements within the same view hierarchy layout file.

Parsing is defined to include data scraping as a technique for extracting text output from a mobile application. An application manager for the mobile device 202, for instance, allows the rendering of the WhatsApp screen 502 on the touchscreen 204. A simulated long-press within the coordinate bounds appearing at 1418 does not reveal a name for the view element 506, thereby indicating that the view element 506 is unnamed. Additionally, an accessibility feature on the mobile device 202 does not work with the view element 506 because it is unnamed. The accessibility feature is designed to aid blind or visually impaired persons in operating the mobile device 202. As a user moves his finger across the touchscreen 204 of the mobile device 202 with the accessibility feature turned on, the mobile device 202 vocalizes the names of view elements contacted. Because the view element 506 is unnamed, a name for it is not vocalized.

For particular embodiments, the mobile device 202 parses the view hierarchy layout file 1300 for WhatsApp when the mobile application is first installed or executed on the mobile device 202. In another embodiment, the mobile device 202 parses the view hierarchy layout file 1300 after updates for WhatsApp are downloaded to the mobile device 202.

For an alternative embodiment, as indicated by broken lines, the mobile device 202 determines 1804 if the unnamed view element is used on the device 202. In some instances, a particular view element is not used by a user of a mobile device. It might be the case, for example, that a mobile application includes two different view elements to perform the same operation, only one of which the user actually taps. In another case, an unnamed view element performs an operation the user never avails himself of. If the user never uses an unnamed view element, or if the view element is not invoked by any voice command or is not referenced in any voice command sequence file, then the view element need not be named for purposes of voice operation. If the mobile device 202 determines 1806 the unnamed view element is not used, then it continues to parse the view hierarchy layout file 1300 for another unnamed view element. If, however, the mobile device 202 identifies 1806 the view element as one that is used, then the mobile device 202 determines 1808 a name for the view element and enters 1810 the name in a data record.

A data record, as used herein, is a data structure, or combination of data structures, which stores or to which is written names for view elements unnamed in a view hierarchy layout file. For some embodiments, a data record includes a non-volatile data structure which is preserved when a mobile device using the data structure powers down. For example, the data record is an electronic file or database that is stored on a magnetic or solid-state drive of the mobile device 202, or other device, and is accessible to the mobile device 202 via the communication interface 108. When the data record is in use, it is loaded into the memory 106. In another embodiment, the data record is a volatile data structure that is created in memory and perishes when the mobile device 202 using the data structure powers down. The data record can be an edited version of a view hierarchy layout file, a substitute version for a view hierarchy layout file, or a supplemental record to a view hierarchy layout file.

For one embodiment, a data record is a view hierarchy layout file which has been edited to include a name for at least one previously unnamed view element. For example, the view hierarchy layout file 1300 is edited to include names for the view elements 306, 506, and 706, and is then overwritten. The overwritten file, which now appears as the view hierarchy layout file 400, is the data record.

In another embodiment, a data record and a view hierarchy layout file represent separate files. For example, the view hierarchy layout file 1300 is edited to include names for the view elements 306, 506, and 706, and is then saved as a separate data record. In this case, the data record can be used as a substitute for the view hierarchy layout file 1300. When WhatsApp is launched, the mobile device 202 uses the data record rather than the view hierarchy layout file 1300 to render screens and run the mobile application.

For a further embodiment, a data record serves as an addendum, rather than a replacement or a substitute, for a view hierarchy layout file. For example, the data record includes names for the view elements 306, 506, and 706, but does not repeat names already appearing in the view hierarchy layout file 1300. When WhatsApp is launched, the mobile device 202 uses the data record together with the view hierarchy layout file 1300 to render screens and run the mobile application.

To determine a name for an unnamed view element, the mobile device 202 uses different techniques in different embodiments. The mobile device 202 can also use a combination of techniques to determine a name for a single view element or use a different technique to determine a different name for each of multiple view elements within the same view hierarchy layout file.

In one embodiment, the mobile computing device 202 determines 1808 the name for the unnamed view element from keywords associated with the view element in a view hierarchy layout file. A keyword, as used herein, is a character string in a view hierarchy layout file that relates to, describes, or otherwise provides information regarding an unnamed view element. Turning to the view hierarchy layout file 1300, for example, a name for the view element 306 does not appear at 1312. Nor does a resource identification, which serves as a programmatic name, appear for the view element 306 at 1314. The view hierarchy layout file 1300 does, however, provide a content description for the view element 306 at 1316. In this case, the provided content description is a keyword the mobile device 202 can use as a name for the view element 306.

As a further example, the view hierarchy layout file 1300 does not provide a name at 1512 for the view element 706, nor does it provide a content description for the view element 706 at 1516. The view hierarchy layout file 1300 does, however, provide a resource identification for the view element 706 at 1514. The mobile device 202 takes the keyword “send” appearing in the resource identification and uses it to name the view element 706.

Neither a name 1412, a resource identification 1414, or a content description 1416 appears in the view hierarchy layout file 1300 for the view element 506. In one embodiment, the mobile device 202 gives the view element 506 a generic name that need not be descriptive of the view element's function. The mobile device 202 might determine 1808 the name for the view element 506 to be “VE-14,” for example, based on it being the fourteenth view element in the view hierarchy layout file 1300. In another embodiment, after parsing the view hierarchy layout file 1300, the mobile device 202 sequentially names each unnamed view element appearing in the file 1300, regardless of if the view element is used or not. The mobile device 202 might determine 1808 the name for the view element 506 to be “UVE-5,” for example, based on view element 506 being the fifth unnamed view element in the view hierarchy layout file 1300.

Using either of the two previous naming methods results in the mobile device 202 determining 1808 the same name for the same view element each time the mobile device 202 parses the view hierarchy layout file 1300. This has advantages for embodiments where the data record is a volatile data structure that is purged, for example, whenever the mobile device 202 is powered down. If the data record is a non-volatile data structure, then the view hierarchy layout file 1300 only needs to be parsed once, for example, after WhatsApp is first installed or updated. Thereafter, the mobile device 202 enters the names determined for unnamed view elements in both the data record and in a voice command sequence file. Upon successive launches of WhatsApp, the names remain intact for both the data record and in a voice command sequence file for voice operation of the WhatsApp mobile application. If, by contrast, the data record is a volatile data structure, then the names entered into the data record are lost each time the memory 106 is purged. This breaks the linking of view elements between the data record and the voice command sequence file by name. If the mobile device 202 determines 1808 the same names for the same view elements each time the mobile device 202 is powered up, or alternatively, each time WhatsApp is launched, then the mobile device 202 only needs to regenerate the data record, without having to rename view elements appearing in the voice command sequence file. Each time the view hierarchy layout file 1300 is reparsed, the same name for the same view element is entered into the data record.

For some embodiments, the mobile device 202 determines 1808 the name for the unnamed view element from a help file for the WhatsApp mobile application. For example, the mobile device 202 can parse written and/or graphical content within a help file and generate a name for a view element based on a “match” that exists between the view element and the parsed content within the help file. A help file, as used herein, is electronic documentation that explains the features and/or operation of a mobile application, in whole or in part, to a user of a mobile device configured to execute the mobile application. A non-exhaustive list of help-file formats include word-processing files, platform-independent portable document format (PDF) files, other electronic manuals, video tutorials, web pages, web applications, programming integrated into the mobile application, and independent programs.

If a WhatsApp help file is hosted by a fileserver, or if it is located on a networked electronic device other than the mobile device 202, then the mobile device 202 accesses the help file using a network connection supported by the communication interface 108. For a particular embodiment, the network connection is an Internet connection and the fileserver is a web server.

From the help file, the mobile device 202 can determine the name for the view element unnamed in the view hierarchy layout file by identifying a correlation between the view element and a view element named in the help file. In one embodiment, determining 1808 the name for the view element is done in a graphical context by comparing a rendering of the view element on the mobile device 202 to a rendering of a comparable view element in the help file. Within the help file, for example, an image of the screen 502 appears that includes an image of the view element 506, which is rendered as a magnifying glass. The mobile device 202 uses a comparative algorithm to compare how images of view elements appearing in the help file compare to how the unnamed view element 506 is rendered on the touchscreen 204. When a match is not made, a next view element from the help file is compared to the unnamed view element 506.

The mobile device can make comparisons based on any known, or as yet unknown at the time of this writing, image comparison technique. After adjusting for scaling differences, parameters upon which to base image comparisons can include, but are not limited to, color, shape, shading, outline, and gradient. When the image of the view element 506 rendered on the touchscreen 204 matches an image of the view element 506 appearing in the help file, the mobile device retrieves the name given to the view element 506 in the help file and enters 1810 the name in the data record.

In another embodiment, determining 1808 the name for the view element is done in an operational context by comparing an operation invoking the view element on the mobile device to an operation invoking a comparable view element in the help file. The mobile device 202 determines a sequence of view elements associated with an operation from a user's tactile interaction with those view elements in performing the operation. In sending a text message, for example, a user might tap a sequence of view elements: VE-1, VE-2, VE-unknown, VE-4, and VE-5, wherein the third view element tapped is unnamed. The mobile device 202 references the help file, which indicates that tapping a sequence of view elements VE-1, VE-2, VE-3, VE-4, and VE-5 sends a text message.

In comparing the two sequences, the mobile device 202 determines each sequence is represented by five view elements. Further, the sequences have four named view elements in common that occur not only in the same order, but also in the same positions. For instance, the view elements VE-2 and VE-4 occupy the second and fourth positions, respectively in both sequences. Based on such comparisons, the mobile device 202 determines the two sequences to be identical and associates the view element VE-3 appearing in the help file with the unnamed view element VE-unknown. The mobile device 202 then retrieves the name given to the view element VE-3 in the help file and enters 1810 the name in the data record for the view element VE-unknown.

For a particular embodiment, a view element is encoded into a view hierarchy layout file for a mobile application with a generic or non-descriptive name. For example, a developer might name the view element 306 “x-316” in the view hierarchy layout file 1300. This name gives no indication of function and is of little benefit to a visually impaired person relying on an accessibility feature on his mobile device 202. If the mobile device 202 can determine an alternate name that is more descriptive, then it enters the more-descriptive name for the view element 306 in the data record. The mobile device 202 might, for instance, determine a more-descriptive name for the view element 306 from a help file for WhatsApp or from the content description “new chat” appearing in the view hierarchy layout file 1300 at 1316. Upon using WhatsApp, the mobile device 202 uses the more-descriptive name for the view element 506 added to the data record over the less-descriptive name for the view element 506 appearing in the view hierarchy layout file 1300.

As an initial method for determining a name for an unnamed view element, or as a fallback method in the event another method fails to produce a name, the mobile device 202 prompts a user for the name of an unnamed view element. The mobile device 202 prompts for the name for the view element on an output component 110 of the mobile device 202 and receives the name for the view element on an input component 114 of the mobile device 202. Prompts can be visual or aural. In one embodiment, the mobile device 202 displays a notification on the touchscreen 204 prompting the user to enter a name for the view element when the user taps on the view element. In another embodiment, the mobile device 202 uses the speakers 208 to play a notification prompting the user to enter a name. In responding to either prompt, the user can enter the name on the touchscreen 204 or speak the name into the microphone 206.

One benefit of entering 1810 a name for a previously unnamed view element in the data record is that an accessibility feature can then be enabled with respect to the newly named view element. After the view element 506 is named in the data record, for example, a visually impaired user having activated the accessibility feature on the mobile device 202 can draw his finger across the view element 506 appearing on the display 204, and the mobile device 202 responsively vocalizes the name for the view element 506.

After determining 1808 names for the view elements 306, 506, 706 unnamed in the view hierarchy layout file 1300 and entering 1810 the names in the data record, the mobile device, for another embodiment, enters the names for the view elements 306, 506, 706 in the voice command sequence file 1600. The voice command sequence file 1600 includes the voice command 900 for the operation of sending a text message that invokes the view elements 306, 506, 706. The names for the view elements 306, 506, and 706 are entered 1812 into the voice command sequence file at 1622, 1624, and 1726, respectively, replacing the character strings indicating the names are unknown.

If the voice command sequence file 1600 did not include a voice command for an operation that invoked any of the view elements 306, 506, 706, then, for an embodiment, the mobile device 202 does not enter the names for any of the view elements 306, 506, 706 into the voice command sequence file 1600. If the voice command 900 were later added to the voice command sequence file 1600, then the mobile device 202 takes the names for the view elements 306, 506, 706 from the data record and enters them into the voice command sequence file 1600 at that time.

For an embodiment, after the names for the view elements 306, 506, and 706 are entered into the voice command sequence file 1600 at 1622, 1624, and 1726, respectively, the voice command sequence file 1600 appears as the voice command sequence file 1100. Similarly, if the data record were an edited version or a replacement version of the view hierarchy layout file 1300, then the data record would appear as the view hierarchy layout file 400 after the names for the view elements 306, 506, and 706 were entered into the view hierarchy layout file 1300 at 1312, 1412, and 1512, respectively. After naming, the same name uniquely identifies the same view element in both the voice command sequence file 1600 and the view hierarchy layout file 1300.

When the mobile device 202 now receives 1814 a voice command for an operation that invokes a previously unnamed view element, the mobile device 202 determines 1816, using the name for the view element, display coordinates for the view element and actuates 1818 the view element using the display coordinates. For example, the mobile device 202 receives 1814 the voice command 900 for sending a text message, an operation that includes invoking the previously unnamed view 506 for searching contacts. In executing the voice command 900, the mobile device 202 takes the name “search” from the voice command sequence file now appearing at 1624 and finds the matching name in the data record to indentify the view element 506. Once the view element 506 is located in the data record, the mobile device 202 uses the display coordinates identified for the view element 506, at 1418, for example, to actuate the view element 506 with a simulated contact to the touchscreen 204 within an area defined by the display coordinates.

In another embodiment, the mobile device 202 does not enter a name determined for a view element into the voice command sequence file. Instead, the view element has or is given a different name in the voice command sequence file. The mobile device 202 creates a symbolic link between the name for the view element in the data record and the name for the view element in the voice command sequence file. For example, the mobile device enters 1810 the name “search” it determines 1808 for the view element 506 into the data record, but the view element 506 has a different name “VE-14” in the voice command sequence file 1600. The mobile device creates a symbolic link that associates the name “search” in the data record with the name “VE-14” in the voice command sequence file 1600. To actuate the view element 506, the mobile device 202 uses the name “VE-14” and the symbolic link to locate the view element named “search” in the data record.

To voice enable WhatsApp on the mobile device 202, the mobile device 202 parses the view hierarchy layout file 1300, determines names for the unnamed view elements, creates the data record, and edits the voice command sequence file 1600 to include the names. To send a text message with WhatsApp on another mobile device using voice, these operations need not be repeated. Instead, the data record the mobile device 202 creates and the voice command sequence file 1600 it edits can be shared with the other mobile device so that the other mobile device can benefit from what was “learned” on the mobile device 202. For an embodiment, the mobile device 202 crowd sources the data record and the edited voice command sequence file 1600 by using its communication interface 108 to upload the two files to a network accessible file server. From the network accessible file server, other network enabled mobile devices can download the data record and the voice command sequence file 1600 and immediately begin to send text messages by voice command.

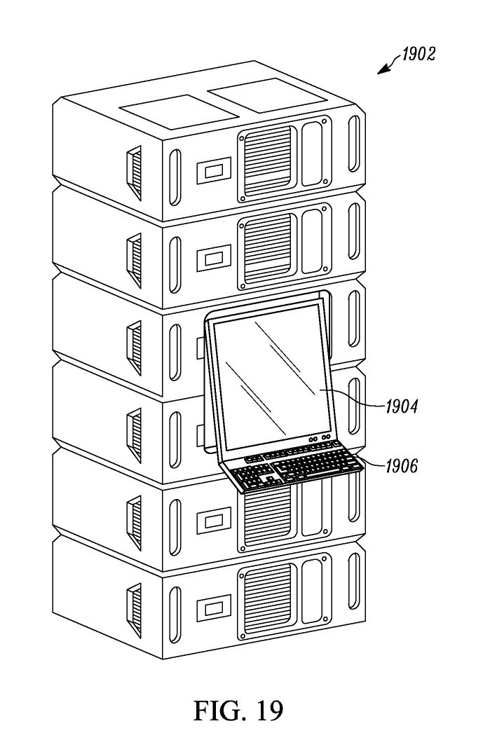

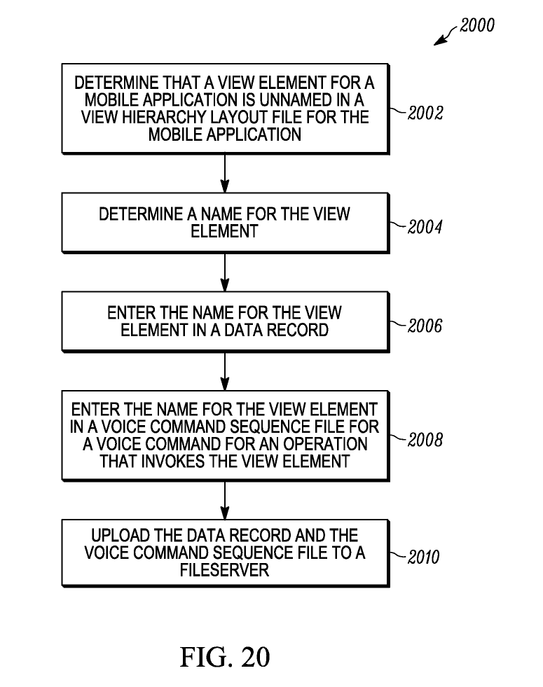

For some embodiments, electronic computing devices not themselves configured to run mobile applications are tasked with creating voice command sequence files and data records to make mobile applications voice capable on other devices. FIG. 19 shows such an electronic computing device 1902, which for an embodiment represents the electronic computing device shown in the block diagram 102. In particular, the electronic computing device 1902 is a server device 1902 that is shown with an input component 114, namely a keyboard 1906, and an output component 110, namely a display screen 1904. Components 104, 106, 108, 112, and 116 are also present within the server device 1902 but are not explicitly shown in FIG. 19. The keyboard 1906 and display screen 1904 allow a user, such as a system administrator or a technician, to program the server device 1902 to perform a method 2000 shown in FIG. 20.

It might be the case, for example, that a corporate entity is making popular mobile applications voice capable on its brand of mobile devices. In performing the method 2000 for a specific mobile application, the server device 1902 parses a view hierarchy layout file for the mobile application. In doing so, the server device 1902 determines 2002 that a view element for the mobile application is unnamed in the view hierarchy layout file. The server device 1902 determines 2004 a name for the view element and enters 2006 the name in a data record for the mobile application. The server device 1902 also enters 2008 the name for the view element in a voice command sequence file for a voice command for an operation that invokes the view element.

When the data record and the voice command sequence file have been created or edited, the server device 1902 uploads 2010 the files to an Internet-accessible fileserver. A user having a correctly branded mobile device and/or with correct login credentials can access the fileserver and download the data record and the voice command sequence file, thereby making his or her mobile device voice operable with the mobile application.

For some embodiments, the server device 1902 tests voice operability for a mobile application with the newly created or edited data record and voice command sequence files before the files are uploaded 2010 to a fileserver and made available for download. For example, the server device 1902 plays an audio recording of the voice command 900 using a speaker and verifies that a text message is successfully sent in response to the voice command 900 being received into a microphone of the server device 1902. By testing many different voice commands, the server device 1902 increases reliability for other mobile devices using the uploaded data record and voice command sequence files to enable voice operation.

To actuate an unnamed view element without touch, a mobile device is reliant upon using hardcoded display coordinates because the mobile device is unable to identify the view element within a view hierarchy layout file by name. This presents a problem in that the display coordinates associated with the view element are dependent upon a display resolution, a display orientation, and may also differ with a change of locale in some instances. The view element will not be rendered at the same display coordinates, for example, if the resolution of the display is changed or the display is rotated from a portrait to a landscape orientation.

In using the data record generated by the server device 1902, the mobile device can now locate the view element by name and is no longer restricted to using fixed coordinates for the view element. As a display resolution or orientation changes, the mobile device locates the view element in the date record by name and then determines current display coordinates for the view element.

For one embodiment, the server device 1902 testing voice operability for a mobile application with the newly created or edited data record and voice command sequence files includes the server device 1902 repeatedly testing actuation of a newly named view element as the view element is rendered at different display coordinates. For example, the server device 1902 actuates the view element by voice in both a portrait and a landscape orientation for a display and determines that the view element was successfully actuated in both cases.

Newer versions of mobile applications often have additional view elements that reflect added functionality. In some instances, one or more of the additional view elements are unnamed. In other instances, a view element named in a previous version of a view hierarchy layout file is unnamed, for whatever reason, in a newer version of the view hierarchy layout file. To remain current with mobile applications as they change, the server device 1902 repeats the method 2000 each time an update is released for a supported mobile application.

In some instances, a change of locale can break links, which are based on names for view elements, between a voice command sequence file and a view hierarchy layout file. The view element 306 has the name “new chat” in the voice command sequence file 1100, as indicated at 1122. The mobile device 202 finds the view element 306 in the view hierarchy layout file 400 because the view element 306 also has the name “new chat” in the view hierarchy layout file 400. If, however, a user sets the mobile device 202 to another locale, for example, when visiting another country where a different language is spoken, the “new chat” name changes in the view hierarchy layout file 400. “New chat” is “neuer chat” in German, for instance, and “nova conversa” in Portuguese.

It might be the case that a different view hierarchy layout file is used for each new locale. It might also be the case that different portions of the same view hierarchy layout file are used for each new locale. In either case, as used herein, a first-language view hierarchy layout file refers to a view hierarchy layout file or a portion of a view hierarchy layout file associated with a first locale or language, for example, the United States or English. A second-language view hierarchy layout file refers to a view hierarchy layout file or a portion of a view hierarchy layout file associated with a second locale or language, for example, Brazil or Portuguese.

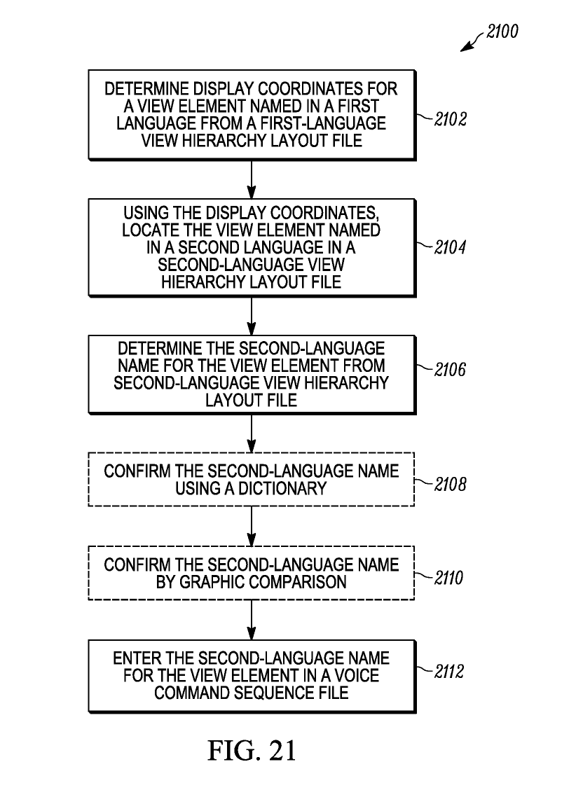

FIG. 21 shows a logical flow diagram illustrating a method 2100 by which an electronic computer device, such as the mobile device 202 or the server device 1902, can enable voice operability for a mobile application running on a mobile device for which a locale setting is changed. In performing the method 2100, the mobile device 202 determines 2102 display coordinates for a view element named in a first language from a first-language view hierarchy layout file. For example, the mobile device 202 determines 2102 the display coordinates 418 for the “new chat” view element named in English from the English view hierarchy layout file 400.

Using the display coordinates, the mobile device 202 locates 2104 the view element named in a second language in a second-language view hierarchy layout file. For example, the mobile device 202 locates in a Portuguese view hierarchy layout file a view element rendered at the display coordinates that match the display coordinates indicated at 418 in the English view hierarchy layout file 400. The method 2100 operates on an assumption that different view hierarchy layout files will likely render the same view element at the same display coordinates, with only the names being different.

From the second-language view hierarchy layout file, the mobile device 202 determines 2106 the second-language name for the view element. For other embodiments, indicated by the dashed blocks, the mobile device may perform confirmation operations. In a first example confirmation operation, the mobile device 202 confirms 2108 the second-language name for the view element is equivalent in meaning to the first-language name for the view element. For example, the mobile device 202 accesses a Portuguese-to-English dictionary and confirms that “nova conversa” means “new chat.” In another embodiment, the mobile device 202 determines a definition for “nova conversa” from a Portuguese dictionary and a definition for “new chat” from an English dictionary, and then confirms the two definitions are the same.

In a second example confirmation operation, the mobile device 202 confirms 2110 the first-language view element rendered by the first-language view hierarchy layout file is graphically equivalent to the second-language view element rendered by the second-language view hierarchy layout file. If the two view elements are rendered alike in appearance, then it is more likely they are in fact the same view element. For different embodiments, the mobile device 202 may apply the first 2108 and second 2110 confirmation operations individually, in conjunction, not at all, or in any order.

The mobile device 202 then takes the second-language name for the view element and enters 2112 it in the voice command sequence file. This links by name the view element in the voice command sequence file to the view element in the second-language view hierarchy layout file. By repeating the method 2100 for each view element included in the voice command sequence file, the mobile device 202 voice enables the mobile application for when the mobile device 202 is set to the second locale or language.

For another embodiment, the server device 1902 repeatedly performs the method 2100 to voice enable voice command sequence files in different locales or languages. The voice command sequence files the server device 1902 so edits or creates are then uploaded to a network-accessible fileserver for crowd sourcing.

In some instances, a user of a mobile device references a help file to learn how to perform an operation. A new user of the mobile device 202, for example, might reference one of six available help files for WhatsApp to learn how to send a text message using the mobile application. It would be advantageous if the user of the mobile device 202 could, by some means, know in advance which of the six available help files is most helpful. Alternatively, if the mobile device 202 provides a single help file in response to a help request, it would be advantageous if the mobile device 202 could determine which of the six help files is “best” based on one or more criteria.

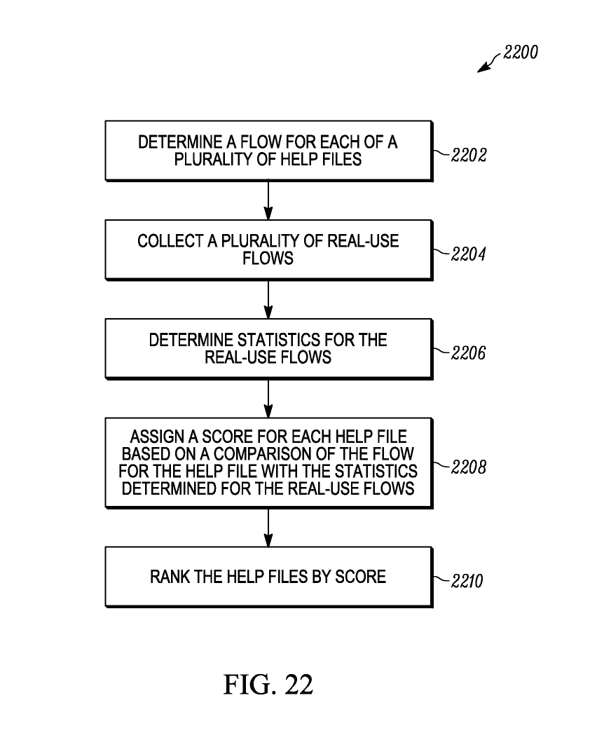

FIG. 22 shows a logical flow diagram illustrating a method 2200 for ranking help files. These rankings can then be used by a user to determine which of many help files to reference, or the rankings can be used by an electronic computer device to determine which of many help files to provide in response to a help request.

In performing the method 2200, an electronic computer device determines 2202 a flow for each of a plurality of help files. A plurality of help files are different help files that are available to a mobile device, or a user of the mobile device, for the purpose of providing aid to the user in performing an operation using a mobile application. A flow, as used herein, is a listed sequence of view elements that are actuated in succession to perform an operation with a mobile device. To send a text message using WhatsApp, for example, a first help file indicates a flow sequence “VE-5, VE-9, VE-21, VE-28, VE-32” and a second help file indicates a flow sequence “VE-5, VE-17, VE-19, VE-32.” For the first help-file flow sequence, five view elements are actuated to send a text message, and in the second help-file flow sequence, only four view elements are actuated to send a text message. The two flow sequences represent two different ways to send a text message with WhatsApp, where only the first and last view elements actuated are the same between the two flows sequences.

The electronic computer device also collects 2204 a plurality of real-use flows. Real-use flows represent flows from actual mobile devices as they are being used to perform operations. Using crowd sourcing, for example, the electronic computer device collects several hundred thousand individual real-use flows from different mobile devices being used to send text messages with WhatsApp. For an embodiment, the electronic computer device anonymously collects the real-use flows without harvesting any personal data.

The large sample size of real-use flows lends itself to statistical analysis. Performing statistical analysis on the sample of real-use flows, the electronic computer device determines 2206 statistics for the sample. Statistics include, but are not limited to, how many different flow sequences are used to perform an operation, how often is each flow sequence used as a percentage or fraction of the total number of collected flows, and how many view elements are actuated for each different flow sequence.

Based on the determined statistics, the electronic computer device assigns a score to each help file. For an embodiment, the electronic computer device identifies the flow sequence for each help file by comparing 2208 it against the real-use flow sequences. The electronic computer device then assigns points to the help file based on characteristic of its flow sequence. Continuing the previous example of a first help file indicating a first flow sequence “VE-5, VE-9, VE-21, VE-28, VE-32” and a second help file indicating a second flow sequence “VE-5, VE-17, VE-19, VE-32,” the electronic computer device assigns more points to the second help file than the first help file because the second flow sequence is shorter than the first flow sequence. It is more convenient to actuate less view elements to perform an operation. Further, the electronic computer device assigns more points to the second help file because the statistical analysis indicates the second flow sequence is more popular than the first flow sequence. In different embodiments, points are assigned to help files based on different criteria.

By summing up the points assigned to a help file, the electronic computing device determines a score for the help file. From a score assigned to each help file, the electronic computing device ranks 2210 the help files by comparing scores. Help files having higher scores, for example, are more helpful than help files having lower scores. Having rankings for help files allows a user to make an informed decision in choosing a help file. It also allows a mobile device to provide a statistically favorable help file in response to a help request.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method performed by a mobile device for enabling voice operation of mobile applications having unnamed view elements, the method comprising:
determining that a view element for a mobile application is unnamed in a view hierarchy layout file for the mobile application;
entering a name for the view element in a data record;
receiving a voice command for an operation that invokes the view element;
determining, using the name for the view element, display coordinates for the view element; and
actuating the view element using the display coordinates.

2. The method of claim 1, wherein actuating the view element using the display coordinates comprises emulating manipulation of the view element.

3. The method of claim 1 further comprising parsing the view hierarchy layout file to determine that the view element is unnamed.

4. The method of claim 1, wherein the data record comprises at least one of:
an edited version of the view hierarchy layout file;
a substitute version for the view hierarchy layout file; or
a supplemental record to the view hierarchy layout file.

5. The method of claim 1 further comprising determining the same name for the view element each time the name is entered into the data record.

6. The method of claim 1 further comprising entering the name for the view element in a voice command sequence file for the mobile device, wherein the voice command sequence file includes the voice command for the operation that invokes the view element.

7. The method of claim 6 further comprising uploading the data record and the voice command sequence file to a network accessible file server.

8. The method of claim 1 further comprising determining the name for the view element from a help file for the mobile application.

9. The method of claim 8, wherein the mobile device uses a network connection to access the help file, wherein the help file is hosted by a fileserver.

10. The method of claim 9, wherein the network connection is an Internet connection and the fileserver is a web server.

11. The method of claim 8, wherein determining the name for the view element is done in a graphical context by comparing a rendering of the view element on the mobile device to a rendering of a comparable view element in the help file.

12. The method of claim 8, wherein determining the name for the view element is done in an operational context by comparing an operation invoking the view element on the mobile device to an operation invoking a comparable view element in the help file.

13. The method of claim 1 further comprising determining the name for the view element from keywords associated with the view element in the view hierarchy layout file.

14. The method of claim 1 further comprising determining the name for the view element, which comprises:
prompting for the name for the view element on an output component of the mobile device; and
receiving the name for the view element on an input component of the mobile device.

15. A method performed by an electronic computing device for enabling voice operation of mobile applications having unnamed view elements, the method comprising:
determining that a view element for a mobile application is unnamed in a view hierarchy layout file for the mobile application;
entering a name for the view element in a data record;
entering the name for the view element in a voice command sequence file for a voice command for an operation that invokes the view element; and
uploading the data record and the voice command sequence file to a fileserver.

16. A method of claim 15, wherein the electronic computing device is a mobile device, the method further comprising:
receiving a voice command for an operation that invokes the view element;
determining, using the name for the view element, display coordinates for the view element; and
actuating the view element using the display coordinates.

17. The method of claim 15 further comprising determining the name for the view element from a help file for the mobile application by determining a correlation between the view element and a view element named in the help file.

18. The method of claim 15 further comprising determining the name for the view element from a resource identification for the view element included in the view hierarchy layout file.

19. A mobile device configured to enable voice operation of mobile applications having unnamed view elements, the mobile device comprising:
a display configured to render view elements;
a microphone configured to receive a voice command that invokes a view element for a mobile application; and
a processing element operatively coupled to the display and the microphone, wherein the processing element is configured to:
determine that the view element is unnamed in a view hierarchy layout file for the mobile application;
enter a name for the view element in a data record;
determine, using the name for the view element, display coordinates for the view element; and
actuate the view element using the display coordinates.

20. The mobile device of claim 19 further comprising a communication interface operatively coupled to the processing element, wherein communication interface is configured to communicate with other electronic devices, and wherein the processing element is further configured to:
enter the name for the view element in a voice command sequence file for the voice command; and
upload the data record and the voice command sequence file to a fileserver using the communication interface.
